(19) United States
(12) Patent Application Publication
(10) Pub. No.: US 2015/0124328 A1
(43) Pub. Date: May 7, 2015

(54) Novel Electronic Screen Shading Device

(71) Applicants: Sharon Beth Dorros, Old Bethpage, NY (US); Brian Aubin, Old Bethpage, NY (US); David Abecassis, Old Bethpage, NY (US); William Dinola, Old Bethpage, NY (US)

(72) Inventors: Sharon Beth Dorros, Old Bethpage, NY (US); Brian Aubin, Old Bethpage, NY (US); David Abecassis, Old Bethpage, NY (US); William Dinola, Old Bethpage, NY (US)

(21) Appl. No.: 13/851,990

(22) Filed: Mar. 28, 2013

(51) Int. Cl. G06F 1/16; G02B 5/00; F21V 1/06

(52) U.S. Cl. CPC G06F 1/1628; F21V 1/06; G02B 5/005
USPC 359/609

(57) ABSTRACT

A device for screen shading can be made of a variety of materials and placed on the electronic screen in such a way as to not block the use of the device, but shades the screen from bright sunlight. This allows for effective electronic screen visualization in bright light conditions where they are the most difficult.

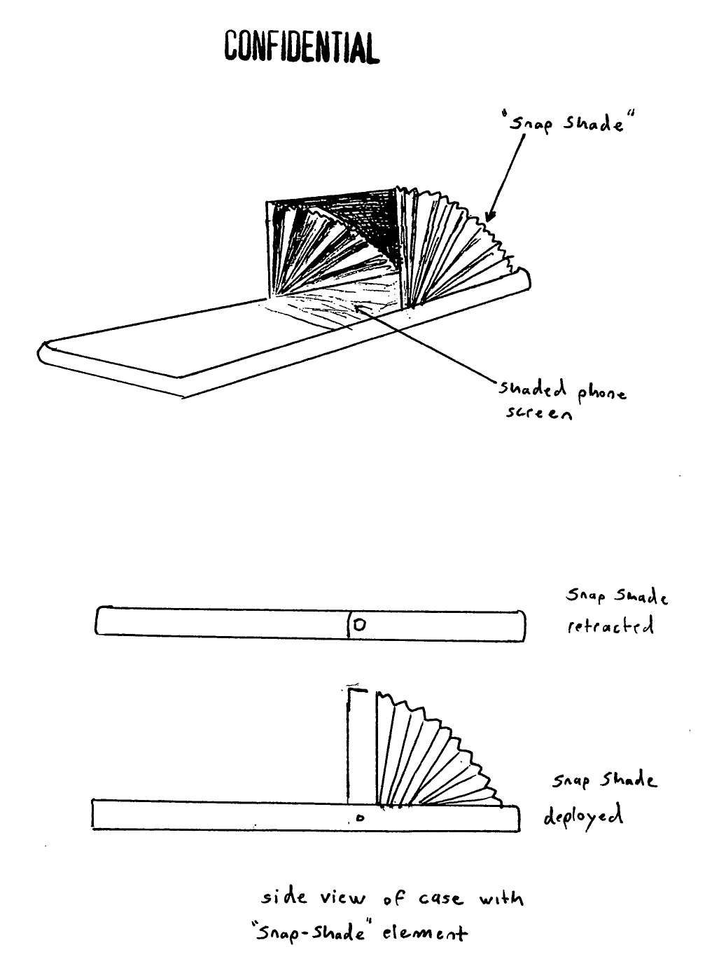

### FIELD OF THE INVENTION

The field of the invention is the field of screen possessing electronic device accessories.

### BACKGROUND OF THE INVENTION

Screen possessing electronic devices often have either reflective or light emitting diode screens which when placed in bright sunlight or other bright light sources. Devices to block glare have focuses on polymer based films with refraction indexes which do not allow non tangential light rays to be reflective back to the eyes. In U.S. Pat. No. 7,970,172 the author Hendrickson describes an electronic method for decreasing screen glare. In U.S. Pat. No. 8,405,908 Phillips et al. describes a shading device for a display. In U.S. Pat. No. 7,970,172 the inventor Hendrickson came up with an invention that shields the eyes of the screen observer when excessive light is detected. The prior art researched does not describe a simple snap on shading device for electronic screens, nor does the fact that shades have been used for centuries in architectural window units appear to make the invention for electronic screens obvious to those skilled in the art, in spite of the simplicity.

### OBJECTS OF THE INVENTION

One object of the invention is to enhance electronic device screen visualization. Another object of the device is to develop an accessory for hand held palm communication devices. Another object of the invention is to develop a shading device for flat screen Internet and computing devices, which are configured in a flat pad format. Another object of the invention is to develop a detachable shading device for computer screens. Another object of the invention is to develop a deployable screen-shading device which can be built into an electronic screen and which can be deployed or retracted as needed for use in bright light.

### SUMMARY OF THE INVENTION

The device is a clip-on or integrated shading panel which when attached or deployed, shades the screen from direct sunlight allowing its visualization and use.

### DETAILED DESCRIPTION OF THE INVENTION

The invention can be a polycarbonate, paper, or composite rectangle with slots or clips which attach it to the side or top of the screen. In some preferred embodiments of the invention is built into the screen and deploys manually, or by releasing a spring, or with a tiny electrical motor.

### EXAMPLES OF THE INVENTION

A palm device size flat square or rectangular piece of injection molded polycarbonate two and a half inches across and two to three inches long has triangular side panels with slots to grasp the edges of the device in such a way as to still allow access to the screen and keypad. The invention is fitted perpendicular to the screen and the side panels shade the screen from angled light. The side panels are on swivels and fold flat when not in use. In another embodiment of the invention, a flat touch-screen computing and communication device eleven by eight inches in diameter is fitted with the invention using hard-durometer elastometirc injection molded rectangular side panels and primary shading panel. The panels are triangular in shape and grip the sides of the device using elastic store force and a textured contact surface for gripping the device. In another embodiment of the invention for flat touch-screen devices, the shading device is an accordion-like folding screen shading device, similar to the deployable shading hood on a baby carriage. The entire device compresses until needed, and then extends to shade the screen when deployed. The above embodiments of the invention can also be configured to fit a laptop screen when the dimensions are adjusted accordingly.

1. A shading device for the electronic screens when attached or deploys from the top of the screen which blocks bright light visual interference.

2. A rectangular attachment for the tops of electronic screens that has side panels the addition of which creates a shaded screen for easier visualization.

3. The claim in 1 where the material is a polycarbonate

4. The claim in 2 where the material is a polycarbonate

5. The claim in 1 where the material is paper on cardboard

6. The claim in 2 where the material is paper on cardboard

7. The claim in 1 where the material is aluminum

8. The claim in 2 where the material is titanium

9. The claim in 1 where the material is magnesium

10. The claim in 2 where the material is magnesium

11. The claim in 1 where the material is titanium alloy

12. The claim in 2 where the material is titanium alloy

13. The claim in 1 where the material is a thermoset composite

14. The claim in 2 where the material is a thermoset composite.
